(19) United States
(12) Patent Application Publication
(10) Pub. No.: US 2014/0089423 A1
(43) Pub. Date: Mar. 27, 2014

(54) SYSTEMS AND METHODS FOR IDENTIFYING OBJECTS DISPLAYED IN A MEDIA ASSET

(71) Applicant: UNITED VIDEO PROPERTIES, INC., Santa Clara, CA (US)

(72) Inventor: Edith Luzia Jäckels, Trier (DE)

(73) Assignee: United Video Properties, Inc., Santa Clara, CA (US)

(21) Appl. No.: 13/628,727

(22) Filed: Sep. 27, 2012

(51) Int. Cl. G06F 15/16

(52) U.S. Cl. 709/206

(57) ABSTRACT

Systems and methods for identifying objects displayed in a media asset are provided. A plurality of messages is received at a remote server from a plurality of users. Each message identifies an object displayed in the media asset. The received messages are processed to extract media asset information and the identified object. The extracted media asset information of each message is cross-referenced with a media asset information database to identify the media asset that corresponds to each of the received messages. The identified objects extracted from each of the plurality of messages are processed to generate information describing the identified object. The generated information for the identified object is stored in the media asset information database for the media asset that corresponds to each of the received messages.

### BACKGROUND

Traditional systems display media assets and provide information about characters displayed on the screen. For example, a window can be presented next to a character to inform the user about the actor playing the character. However, the characters/actors about which these systems provide such information are determined by the system operator. Thus, there may be certain characters/actors in the media asset that are displayed for which no information is available. Accordingly, these systems lack an effective mechanism to allow the users to easily obtain information about characters or objects displayed in a media asset which have not been preselected by the system operator.

### SUMMARY

In view of the foregoing, systems and methods for identifying objects displayed in a media asset in accordance with various embodiments of the present invention are provided.

In some embodiments, a user may identify an object being displayed and provide description information for the displayed object. The description information may be transmitted to a remote server as a message. In particular, a first of the plurality of messages may be generated by user equipment associated with a first of the plurality of users. An image of the media asset (e.g., a video) may be displayed with the user equipment associated with the first user. The image may include a plurality of objects. An indication with each of the plurality of objects may be displayed that indicates whether descriptive information is available for display for the respective object.

In some embodiments, a first input may be received from the first user at the user equipment selecting an object displayed in the image. In particular, the user may select the indicator that indicates description information is not available for the given object. A second input may be received from the user at the user equipment describing the selected object. The description of the selected object may be added to a first message along with automatically determined playback position and display location of the object. The first message may be transmitted to a remote server.

In some embodiments, a plurality of messages from a plurality of users is received at a remote server in a similar manner as the first message. Each message may identify an object displayed in the media asset. The received messages are processed to extract media asset information and the identified object. The extracted media asset information of each message is cross-referenced with a media asset information database to identify the media asset that corresponds to each of the received messages. The identified objects extracted from each of the plurality of messages are processed to generate information describing the identified object. In particular, a display location and playback position may be determined from the extracted identified objects. Description information may also be determined from the extracted identified objects. The generated information for the identified object is stored in the media asset information database for the media asset that corresponds to each of the received messages.

In some embodiments, the remote server may be associated with a social network, website, blog or news site. In some embodiments, the generated information may include a name of the identified object or biographic description of the identified object. In some embodiments, the identified object may be a character in the media asset or items included in a scene of the media asset.

In some embodiments, the identified objects may be selected from an image of the media asset. In particular, the image of the media asset may be processed at the playback position to identify a plurality of objects in the image. A plurality of display locations of the identified objects in the image may be computed. A representative location associated with each of the plurality of objects extracted from the messages may be computed. In particular, an average of the display locations may be determined based on display locations specified in each of the received messages. The plurality of display locations of the identified objects in the image may be compared with the representative location. A determination may be made as to which one of the plurality of objects in the image is associated with a location that is closest to the representative location. The description information for the identified object in the received messages may be generated based on the object in the image determined to be associated with the location that is closest to the representative location.

In some embodiments, a representative description of the selected object may be generated based on a description included in each of the received messages for the identified object that is common among a majority of the received messages. In particular, a majority of the received messages may include a description of the object being “Tom” while the remaining messages may include a description of the same object being “Jerry”. Accordingly, the representative description may be assigned to be “Tom” for the given object since a majority of the received messages indicated the description for the object to be “Tom”.

In some embodiments, the information describing the identified object may be transmitted to user equipment. The user equipment may display the information describing the identified object when the user equipment displays the identified object in the media asset. In particular, the user equipment may generate an indicator that indicates the availability of the information for a given object being displayed at the representative playback position of the media asset at the representative display location. In response to receiving a user selection of the displayed indicator, the user equipment may display the representative information that was generated based on a plurality of received messages.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen of identifying an object displayed in a media asset in accordance with an embodiment of the invention;

FIG. 6 shows an illustrative display screen of information for an object displayed in a media asset being provided in accordance with an embodiment of the invention;

FIG. 7 shows an illustrative display screen of media object information entry for a displayed object in the media asset in accordance with an embodiment of the invention;

FIG. 8 shows illustrative database entries identifying objects displayed in media assets in accordance with an embodiment of the invention;

FIG. 9 is a diagram of a process for identifying an objected displayed in a media asset using messages received from a plurality of users in accordance with embodiments of the invention; and

FIG. 10 is a diagram of a process for identifying an object in an image and generating information for the object using messages received from a plurality of users in accordance with embodiments of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), messages from a crowd of users on a social network, messages from a crowd of users posted to a blog or website, genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. In some implementations, this data may be referred to as a data feed. As referred to herein the term “crowd” should be understood to mean any number of users greater than one.

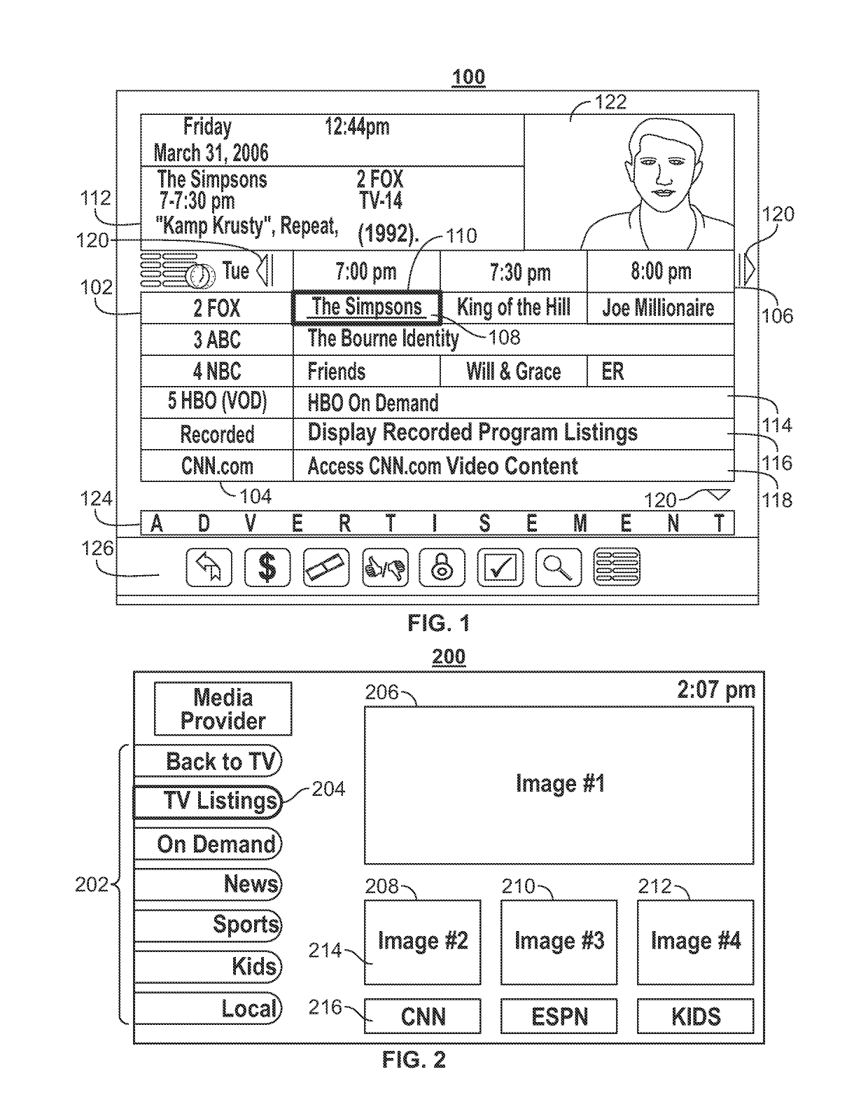

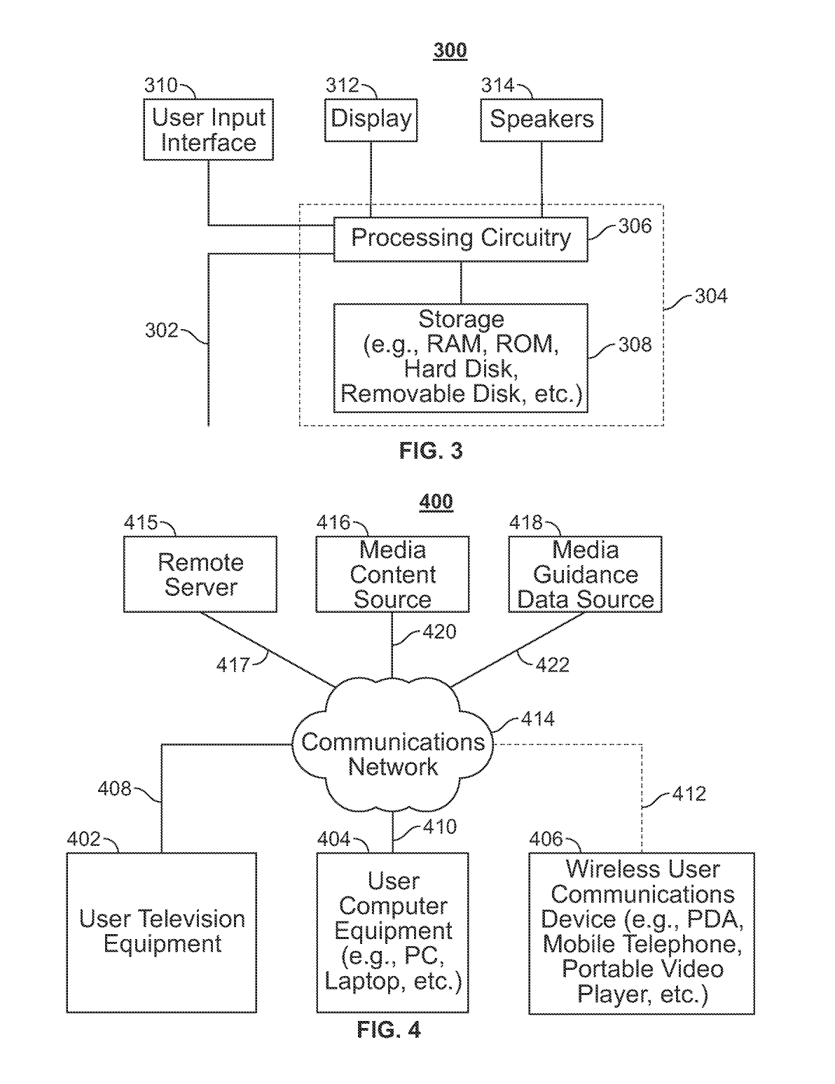

FIGS. 1-2 show illustrative display screens that may be used to provide media guidance data. The display screens shown in FIGS. 1-2 and 5-7 may be implemented on any suitable user equipment device or platform. While the displays of FIGS. 1-2 and 5-7 are illustrated as full screen displays, they may also be fully or partially overlaid over content being displayed.

A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

As referred to herein, the phrase “in response” should be understood to mean automatically, directly and immediately as a result of or automatically based on the corresponding action where intervening inputs or actions may occur.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other airtimes or ways of receiving a program, recording a program, enabling series recording of a program, setting program and/or channel as a favorite, purchasing a program, identifying objects displayed in a media asset, or other features. Options available from a main menu display may include search options, VOD options (e.g., fast-access playback operations), parental control options, Internet options, cloud-based options, device synchronization options, second screen device options, options to access various types of media guidance data displays, options to subscribe to a premium service, options to edit a user's profile, options to access a browse overlay, or other options. As referred to herein, the term “object” means a character, product being advertised, advertisement, furniture, item in a scene, background item, or other article in an image or video that has distinguished boundaries that are discernible from other articles in the image or video.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

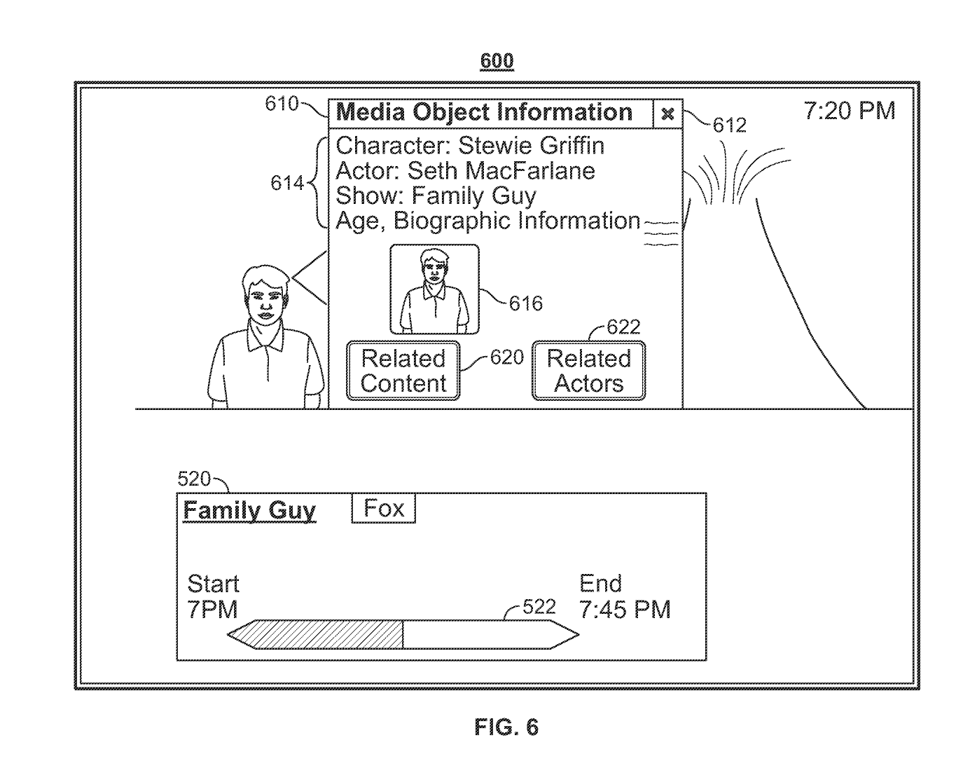

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

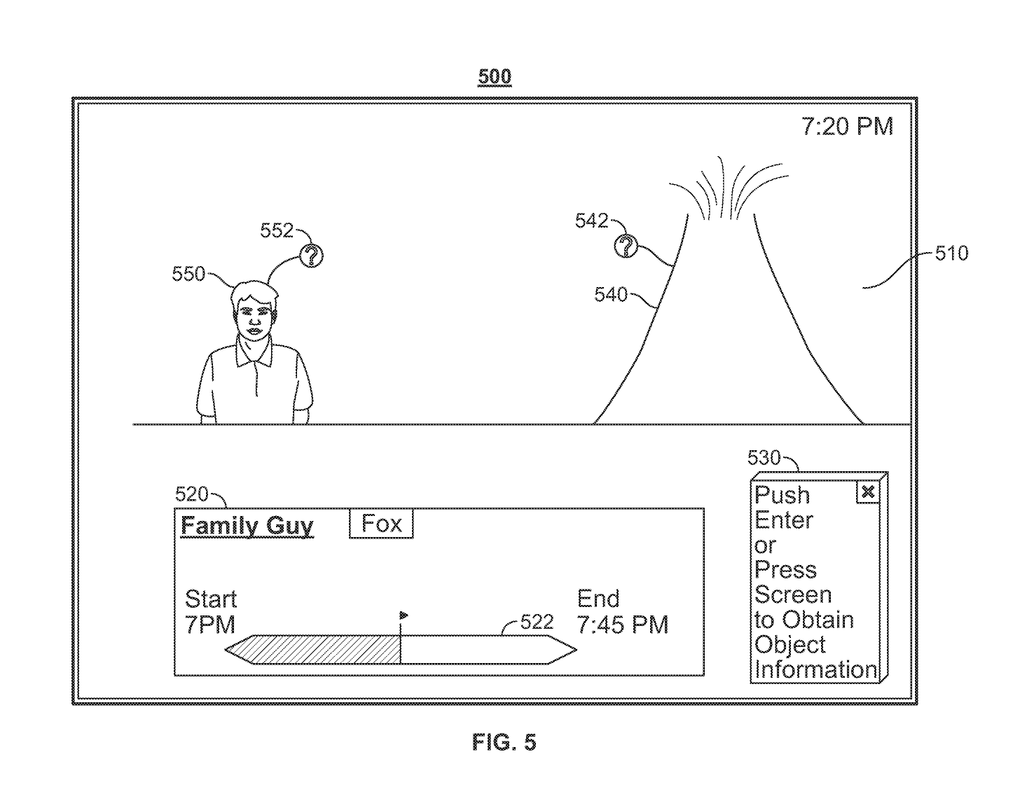

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

In some embodiments, a viewing history may be stored in storage 308 for a user. The viewing history may include indications of which media assets have been viewed by a given user. The viewing history may also include, for each media asset, which portion or portions have or have not been viewed by the user. In some implementations, the viewing history may include indications of which users in a group of users have seen or viewed a media asset or a particular segment of a media asset. The group of users may be users in a certain geographical location (e.g., in the same home) or users that are associated with each other on a social network.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

Control circuitry 304 may include facial recognition circuitry. Facial recognition circuitry may identify faces of characters displayed in a media asset. Facial recognition circuitry may include a database of faces that associates identified faces to names of people (e.g., actors). In some implementations, the database of faces may be stored on a remote server. For each face facial recognition circuitry identifies, facial recognition circuitry may transmit a query to the database of faces requesting the name of the person associated with the identified face. When the database of faces determines that the identified face is stored in the database, the database of faces may return to facial recognition circuitry the name associated with the identified face. When the database of faces determines that the identified face is not stored in the database or is not associated with a name, the database of faces may transmit a communication back to facial recognition circuitry indicating that the identified face is unknown.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. User input interface 310 may include keys or displayed options that enable a user to instruct control circuitry 304 to identify a displayed object corresponding to the key pressed. For example, user input interface may be a touch-screen device such that a video displayed underneath or above the touch-screen allows a user to point by pressing on the touch-screen to the object the user requests control circuitry 304 to identify. In particular, user input interface 310 may enable a user to request information to be displayed for an object displayed in the media asset if information is indicated to be available. Alternatively, user input interface 310 may enable a user to select an object displayed in the media asset for which information is indicated to be not available and for which the user would like to provide information.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Each user of the user equipment devices may be associated with different users in a crowd of users. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. Media guidance application data may include a data feed that includes messages from a plurality of users in a crowd. The messages in the data feed may be posted by the users in the crowd onto a social network, a blog, a news feed, a website or any other medium in which multiple users may provide messages. In some implementations, the messages may include information that identifies objects displayed in a media asset as well as identifications of the media asset. The messages may be posted by each of the users to the social network, blog, news feed or website automatically or manually. The messages may be generated by user equipment 300 associated with each user in response to the respective users selecting an object (e.g., character, product, or background article) displayed in a media asset and supplying information for the selected object (e.g., character, product, or background article). Specifically, each message may include a position (along the x-axis and y-axis) of the object in the display relative to other objects in the display, playback position of the object (e.g., 20 minutes past the beginning of the media asset), and a description of the object (e.g., character/actor name or scene information) input by the user. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of remote server 415. When executed by control circuitry of remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, access to messages posted by users in a crowd, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 (of a user equipment device or remote server 415) may retrieve a media asset (or portion of the media asset) from storage 308. Control circuitry 304 may present the retrieved media asset to the user and receive a user request to identify an object being displayed. Control circuitry 304 may store, as a playback position of the object, a current playback position at the time the request to identify the object was received. Control circuitry 304 may also store a display position of the object selected by the user (e.g., x and y coordinates relative to other objects or reference points). Control circuitry 304 may present a user with options to describe the selected object. In response to receiving input from the user describing the object, control circuitry 304 may store the description, image position, and playback position in storage 308. Control circuitry 304 (e.g., of a user equipment device) may generate a message that includes an identification of the media asset and the object and transmit that information to remote server 415. For example, control circuitry 304 may present a media asset and after 20 minutes of playback, a user input selecting a given character being displayed may be received by control circuitry 304. In response, control circuitry 304 may store the playback position and relative position of the selected character. Control circuitry 304 may receive input from the user specifying an actor's name who is playing the character, as well as other descriptive information (e.g., related or unrelated media assets the actor has played in). Control circuitry 304 may generate a message that includes a title of the media asset and the character information (e.g., playback position, image position and actor name).

In some embodiments, after remote server 415 receives a predetermined number of messages from users marking a similar object, remote server 415 may derive or compute the playback position of the object and image position of the object being identified. For example, remote server 415 may compute an average of the playback positions and an average of the image positions of the object. Remote server 415 may also identify a common description of the object received from a majority of the messages. Remote server 415 may store the common description, playback position and image position for the object in a media asset database entry associated with the media asset from which the object was selected. After another user requests access to the media asset, the user may play back the same media asset. Control circuitry 304 may present the user with an indication that information associated with a given object is available. In response to control circuitry 304 receiving a user selection of the object, control circuitry 304 may retrieve the information associated with the object and display the description that was common among a majority of the received messages to the user.

In some embodiments, a remote server 415 coupled to communications network 414 may host a website, social network, blog and/or news site. Remote server 415 may include the same or similar circuitry or components as control circuitry 304. A crowd of users may post messages to remote server 415 that identify a media asset and objects displayed within the media asset.

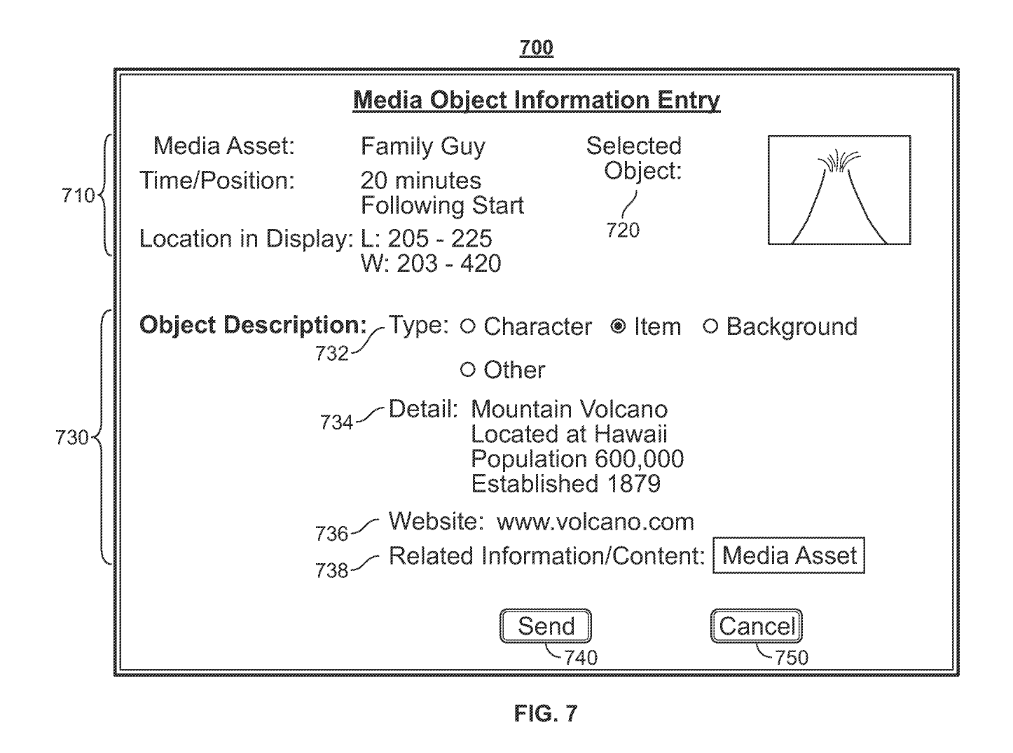

FIG. 5 shows an illustrative display screen 500 of identifying an object displayed in a media asset in accordance with an embodiment of the invention. Screen 500 includes a media asset 510, an information overlay 520, and an object identification prompt 530.

The media asset displayed in screen 500 may be a linear or non-linear media asset. For example, in some implementations, the media asset may be a live broadcast of an event. A user in the crowd may be consuming the media asset and provide input to control circuitry 304 requesting additional information. In response, control circuitry 304 may generate for display information overlay 520. Information overlay 520 may include any information identifying or describing the media asset (e.g., a title, detailed description, content rating, etc.) and a transport bar 522. Transport bar 522 may indicate to the user a current position within the media asset relative to a start and end time of the media asset.

In some embodiments, control circuitry 304 may determine whether objects displayed in media asset 510 have information (e.g., description information) associated with them. Specifically, control circuitry 304 may retrieve a data structure associated with a current playback position to determine what objects are being displayed in media asset 510 and whether or not information is available for the objects being displayed. The information may be provided to control circuitry 304 from remote server 415 (FIG. 4) and/or media guidance data source 418. Some of the information for objects displayed in media asset 510 may have been generated by a system operator while other information may have been generated based on messages received from other users identifying objects being displayed in media asset 510. In response to determining that a given object has information associated with the object, control circuitry 304 may generate for display with the given object a first visual indicator 552 (e.g., an exclamation mark). In response to determining that a given object lacks or does not have information associated with the object, control circuitry 304 may generate for display with the given object a second visual indicator 542 (e.g., a question mark). Visual indicators 552 and 542 may be interactive to allow the user to select a given object to either cause control circuitry 304 to present information for the object, if available, or to cause control circuitry 304 to request input from the user describing the object being displayed, if information is not available. Although only two indicators 552 and 542 are shown in screen 500, any number of these indicators may be included in screen 500 depending on the number of objects being displayed in media asset 510.

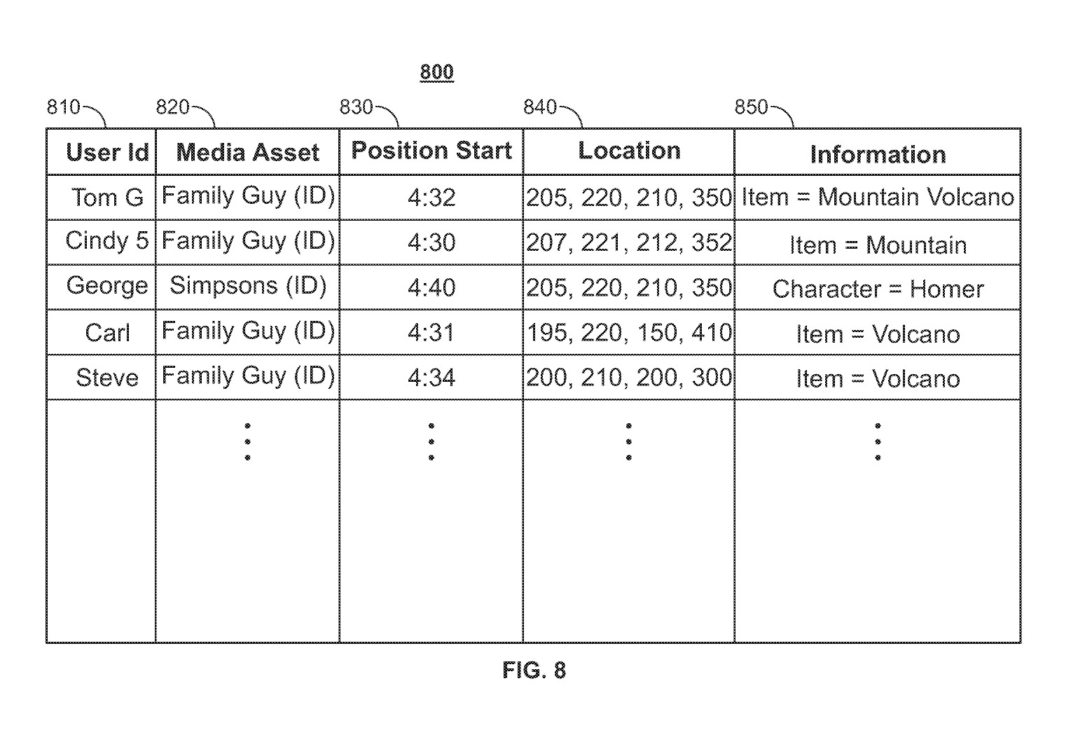

In some embodiments, in response to receiving a user selection of indicator 552 or 542, control circuitry 304 may pause display of media asset 510. For example, in case media asset 510 is a live broadcast media asset, control circuitry 304 may begin buffering the media asset in response to receiving user selection of indicator 552 or 542 and pause the display of media asset 510 at the point when selection of indicator 552 or 542 was received. In some implementations, control circuitry 304 may pause and/or buffer media asset 510 when indicator 542 is selected (e.g., indicating the user would like to input information about the object) but not whether indicator 552 is selected (e.g., indicating the user would like to receive information about the object). In such circumstances, information presented in window 610 (FIG. 6) describing the selected object may move along with the selected object on the screen. For example, if the selected object is a character, window 610 may provide the name of the actor playing the character and may be displayed at the same point relative to the location of the character while the character continues to move about the screen.

In some embodiments, a user may select an object being displayed in media asset 510 to cause information (e.g., description information) for the selected object to be displayed. For example, control circuitry 304 may receive a user input (e.g., using user input interface 310) selecting first visual indicator 552. In response, control circuitry 304 may present a window 610 (FIG. 6) that includes descriptive information about the object corresponding to first visual indicator 552. The information included in window 610 may have been generated based on messages remote server 415 received from a plurality of users. For example, remote server 415 may receive a plurality of messages from users who selected second visual indicator 542 and supplied information describing the corresponding object. After a threshold number of messages were received by remote server 415, remote server 415 may update the media asset information associated with media asset 510 so that when the corresponding object is displayed subsequently, first visual indicator 552 is presented informing the user of the availability of the information supplied by other users.

FIG. 6 shows an illustrative display screen 600 of information for an object displayed in a media asset being provided in accordance with an embodiment of the invention. Screen 600 may include window 610 and media asset 510. Window 610 may include a close option 612. In response to receiving a user selection of close option 612, control circuitry 304 may remove window 610 from the display and return the user to screen 500. In case media asset 510 was being paused while window 610 was presented, control circuitry 304 may automatically resume playback from the point at which indicator 552 was selected in response to receiving the user selection of close option 612.

Control circuitry 304 may retrieve from storage 308 information associated with object 550 corresponding to identifier 552 selected by the user. Control circuitry 304 may populate fields 614 in window 610 with the retrieved information. For example, window 610 may include fields that inform the user about an actor/actress name and the role name of the character selected when object 550 is a character. Similarly, window 610 may include fields that inform the user about a product being advertised when object 550 is a product in an advertisement or commercial. Fields 614 may include biographical information about the actor/actress, information about the character in media asset 510 in the context of the plot of media asset 510 when object 550 is a character in media asset 510. In case media asset 510 is a factual program, fields 614 may include the name of the person corresponding to object 550 and/or a short biography about the person. Any other suitable information may be included in fields 614. For example, when object 550 selected by the user is not a character but is a product or background item (e.g., a mountain), fields 614 may include the producer of the product (e.g., brand name), the company associated with the product, sponsor information, where to purchase the product, description about the geographical location of the background item, a link to a website associated with the object, or any combination thereof.

In some embodiments, window 610 may include a representative image or video 616 of the selected object. Window 610 may include an option 620 to view related content and/or an option 622 to view related actors/persons. In response to receiving a user selection of option 620, control circuitry 304 may display a window or prompt that includes media assets or content related to the selected object. For example, control circuitry 304 may retrieve one or more of fields 614 (e.g., actor name) displayed in window 610 and perform a search over the Internet or locally for other media assets or content related to the retrieved information (e.g., other movies or shows the actor plays in). Control circuitry 304 may then display the identified other media assets and content related to the retrieved information. In response to receiving a user selection of option 622, control circuitry 304 may display a window or prompt that includes other actors related to the selected object. For example, control circuitry 304 may retrieve one or more of fields 614 (e.g., actor name) displayed in window 610 and perform a search over the Internet or locally for other actors related to the retrieved information (e.g., other actors that play together with the actor identified in field 614). Control circuitry 304 may then display the identified other actors related to the retrieved information.

In some embodiments, the selected object may correspond to a product or item being advertised (e.g., in a commercial). Window 610 may include an option (not shown) to order the advertised product. In response to receiving a user selection of the option to order the product, control circuitry 304 may retrieve a profile associated with the user and from the profile an account associated with the user. Control circuitry 304 may utilize the account information associated with the user to communicate with the entity associated with the advertised product to place the order for the product. In some implementations, control circuitry 304 may transmit a communication over the Internet to a website and use the information included in window 610 to identify the product and complete a financial transaction purchasing the product. For example, control circuitry 304 may retrieve one or more of the fields (not shown) (e.g., product name) displayed in window 610 and perform a search over the Internet or locally for products related to the retrieved information (e.g., other associated names or brands of the product or product bar codes or UPC codes). Control circuitry 304 may then utilize the retrieved information to complete the financial transaction for the product purchase.

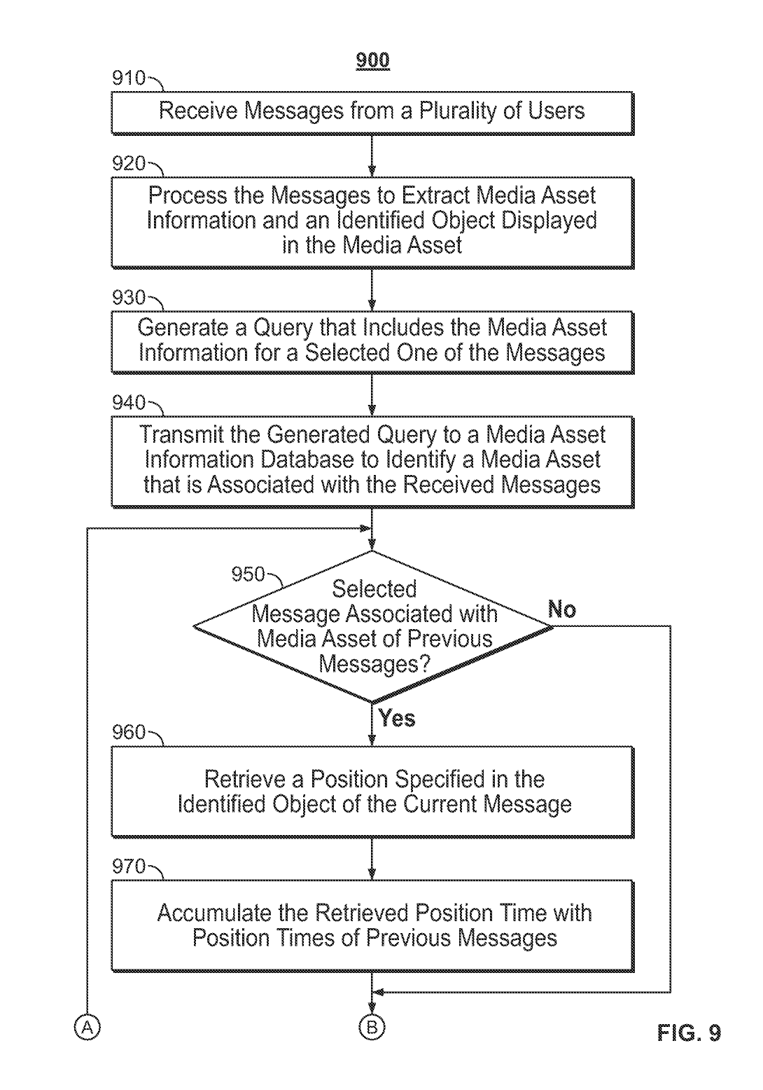

Referring back to FIG. 5, in some embodiments, a user may select an object being displayed in media asset 510 to input information (e.g., description information) for the selected object. For example, control circuitry 304 may receive a user input (e.g., using user input interface 310) selecting second visual indicator 542. In response, control circuitry 304 may navigate the user to screen 700 (FIG. 7). Screen 700 allows a user to enter information for an object associated with visual indicator 542 selected by the user and is described in more detail below in connection with FIG. 7. Control circuitry 304 may store in storage 308 information supplied by the user with screen 700 as information describing the object displayed in the media asset corresponding to second visual indicator 542.

In some embodiments, a playback position of an object displayed in a media asset that is selected by a user may automatically be identified and stored by control circuitry 304 in response to receiving user input selecting the object for which the user would like to input information. In particular, while accessing media asset 510, control circuitry 304 may receive a user input requesting to identify an object being displayed. For example, control circuitry 304 may receive a user selection of a background object 540 (e.g., a mountain in the scene) being displayed in the media asset indicating that the user would like to provide information about the selected background object 540. In response, control circuitry 304 may store an indication of a playback position at the time the user request was received. For example, the current playback position may correspond to four minutes after start of the media asset playback and the user request to identify background object 540 may be received at the four minute mark. Accordingly, control circuitry 304 may store an indication that the request to identify background object 540 was received at the four minute mark (e.g., four minutes from the start of the media asset). Control circuitry 304 may automatically store this indication as a playback position of the object displayed in the media asset.

In some embodiments, a display position of an object displayed in a media asset that is selected by a user may automatically be identified and stored by control circuitry 304 in response to receiving user input selecting the object for which the user would like to input information. In particular, while accessing media asset 510, control circuitry 304 may receive a user input requesting to identify an object being displayed. For example, control circuitry 304 may receive a user selection of a background object 540 (e.g., a mountain in the scene) being displayed in the media asset indicating that the user would like to provide information about the selected background object 540. In response, control circuitry 304 may store an indication of a display position (e.g., x and y coordinates) at the time the user request was received. For example, the object may be displayed in the middle left quadrant of the display and the user request to identify background object 540 may be received when the object is displayed in the middle left quadrant. Accordingly, control circuitry 304 may store an indication that when the request to identify background object 540 was received background object 540 was displayed in a region of the display corresponding to the rectangle having the coordinates 200, 500, 100, 300 (where the first two numbers represent the two points on the x-axis and the second two numbers represent the two points on the y-axis). It should be understood that while the disclosure pertains to identifying objects using a rectangular region any other type of geometric region (e.g., circular, triangular or any other polygon) may be used to identify a location or image position in a display of an object. Control circuitry 304 may automatically store this indication as a display position of the object displayed in the media asset.

In some embodiments, an identifier of the media asset being displayed when the object displayed in the media asset is selected by a user may automatically be stored by control circuitry 304 in response to receiving user input selecting the object for which the user would like to input information. In particular, while accessing media asset 510, control circuitry 304 may receive a user input requesting to identify an object being displayed. For example, control circuitry 304 may receive a user selection of a background object 540 (e.g., a mountain in the scene) being displayed in the media asset indicating that the user would like to provide information about the selected background object 540. In response, control circuitry 304 may store an identifier of the media asset being displayed at the time the user request was received. For example, the title of the media asset may be retrieved from storage 308 or some other unique identifier (e.g., alphanumeric sequence or time and channel information). Control circuitry 304 may automatically store this identifier as the media asset identified in the message.

Control circuitry 304 may generate a message that includes: the description information received from the user (e.g., via screen 700 (FIG. 7)); the automatically stored display position of the selected object within media asset 510; the identifier of the media asset; and the automatically stored playback position of the selected object within media asset 510. Control circuitry 304 may include other information that uniquely identifies the media asset being consumed by the user in the message (e.g., any information included in overlay 520 and/or other information not included in overlay 520). For example, control circuitry 304 may retrieve data that identifies the media asset being consumed from a local or remote media asset schedule information database. For example, control circuitry 304 may include a title or unique alphanumeric sequence as the information that uniquely identifies the media asset being consumed by the user in the message. Control circuitry 304 may transmit the generated message to remote server 415 that collects similar messages from other users in the crowd of users for media asset 510.

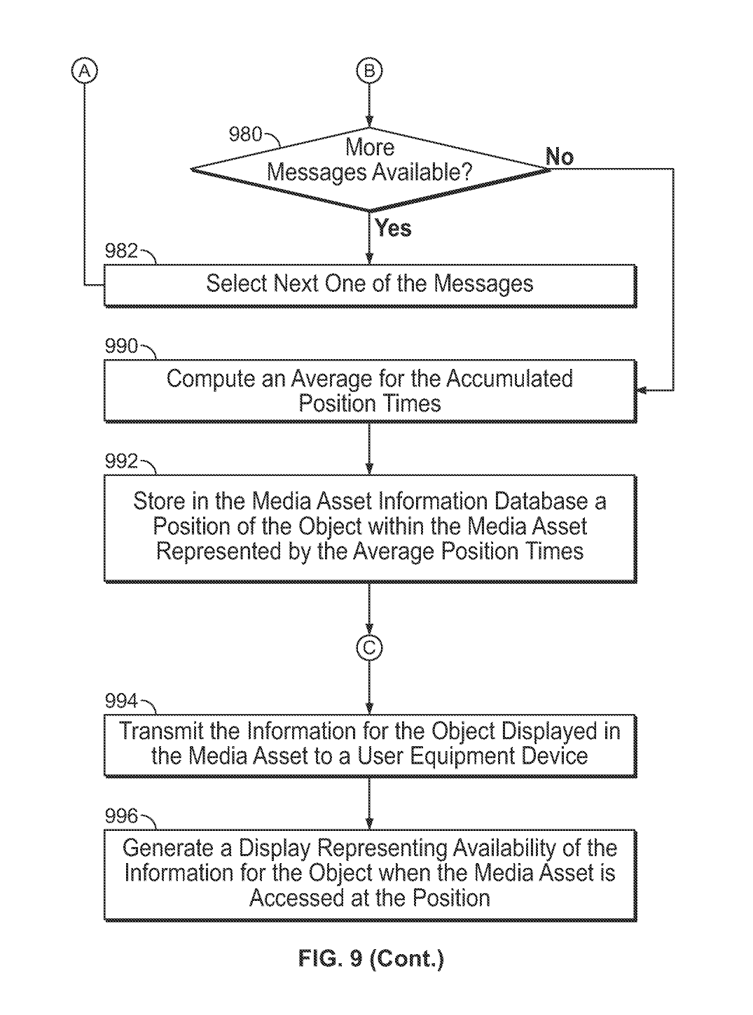

In some embodiments, remote server 415 may collect messages received from various users in a crowd that identify the media asset and display and playback positions of selected objects displayed within a media asset and provide description information for the selected objects. Specifically, as each message is received from a user in the crowd, remote server 415 may process the received message to retrieve a playback position of the object, display location of the object, media asset information and description information for the object from the messages. Remote server 415 may store the retrieved information in a database 800 (FIG. 8). For example, database 800 may include a userID field 810, media asset field 820, playback position field 830, display location field 840, and/or description information field 850.

Remote server 415 may generate and store in database 800 all the extracted information from each received message in a respective database entry. Remote server 415 may extract a user identification (e.g., a user name) from a received message and store that information in field 810 of the entry. Remote server 415 may extract a media asset identification from the received message (e.g., a unique number or title associated with the media asset) and store that information in field 820 of the entry. Remote server 415 may extract a playback position of the object from a received message and store that information in field 830 of the entry. Remote server 415 may extract a display location position from a received message and store that information in field 840 of the entry. Remote server 415 may extract description information from a received message and store that information in field 850 of the entry.

Remote server 415 may monitor the number of entries a particular media asset receives. For example, remote server 415 may compute how many entries in database 800 have a media asset field 820 that is identical or substantially similar or corresponds to a same media asset. Remote server 415 may compare the computed number of entries having the identical or substantially similar media asset field 820 with a predetermined or dynamic threshold. In response to determining that the number exceeds the predetermined or dynamic threshold, remote server 415 may process playback position field 830, description information field 850 and display location field 840 for each of the messages having identical or substantially identical fields 820 to determine a playback position, display location and description information for a given object in the media asset corresponding to field 820. For example, in response to determining that a predetermined number of messages (e.g., 100 messages) have been received for a given media asset, control circuitry 304 may collectively process the messages to identify a playback position, display location and description information for an object displayed within the media asset identified by the messages.

In some embodiments, remote server 415 may monitor the entries stored in database 800 to determine whether any entry corresponds to a trusted user. For example, remote server 415 may generate an SQL query for database 800 to retrieve any entry having a specific username stored as field 810. Specifically, content curators, product advertisement entity, product placement entity, or editors may be among the crowd of users that supply messages to remote server 415. In case remote server 415 receives and stores an entry in database 800 that corresponds to a message received from a content curator or editor, remote server 415 may immediately assign as the playback position, display location and description information of an object the playback position, display location and description information specified in the database 800 entry corresponding to the message received from the content curator or editor. In such circumstances (e.g., when an entry corresponds to a content curator or editor), remote server 415 may not wait for a predetermined number of messages corresponding to a particular media asset to be received before determining and storing playback position, display location and description information for an object displayed in a media asset. Also, in such circumstances (e.g., when an entry corresponds to a content curator or editor), remote server 415 may not collectively process all messages corresponding to a given media asset to compute a representative playback position, display location and description information of the media asset object (e.g., the computed average discussed below). Instead, remote server 415 may retrieve the values stored in fields 830, 850 and 840 for the entry having field 810 that matches a content curator, advertiser, product placement entity, or editor username.

In some embodiments, remote server 415 may retrieve playback position of an object from each received message by retrieving data stored in playback position field 830 of each entry for each message having an identical or similar media asset field 820. Remote server 415 may compute a representative value (e.g., an average) of all the playback positions included in the messages received from the users in the crowd by computing a representative value (e.g., an average) of all the retrieved data. For example, media asset “Family Guy” may have four entries stored in database 800. Each entry for media asset “Family Guy” may indicate a corresponding playback position in field 830. Remote server 415 may retrieve the four object playback positions from field 830 of each entry (e.g., 4:32, 4:30, 4:31 and 4:34) and compute an average of those playback positions (e.g., 4:32). Remote server 415 may store the representative value (e.g., computed average) of the starting positions as the playback position of the selected object in the media asset.

In some embodiments, remote server 415 may retrieve display locations of an object from each received message by retrieving data stored in display location field 840 of each entry for each message having an identical or similar media asset field 820. Remote server 415 may compute a representative value (e.g., an average) of all the display locations included in the messages received from the users in the crowd by computing a representative value (e.g., an average) of all the retrieved data. For example, media asset “Family Guy” may have four entries stored in database 800. Each entry for media asset “Family Guy” may indicate a corresponding object display location in field 840. Remote server 415 may retrieve the four object display locations from field 840 of each entry (e.g., 5:31, 5:32, 5:30 and 5:30) and compute an average of those locations (e.g., 5:31). Remote server 415 may store the representative value (e.g., computed average) of the object display locations as the object display location of the object in the media asset.

In some embodiments, remote server 415 may retrieve description information of an object from each received message by retrieving data stored in information field 850 of each entry for each message having an identical or similar media asset field 820. Remote server 415 may select a description for the object to be the description information common to a majority of the messages that are received. For example, if more than half of the messages received specify a description of the object to be “Volcano” and the remaining messages specify a description of the object to be “Clouds”, control circuitry 304 of remote server 415 may select the description for the object to be “Volcano.” Similarly, if more than half of the messages received specify a description of the object to be “Queen Elizabeth II” (when a character or actor displayed in the media asset is the selected object) and the remaining messages specify a description of the object to be “Princess Margaret”, control circuitry 304 of remote server 415 may select the description for the object to be “Queen Elizabeth II.”

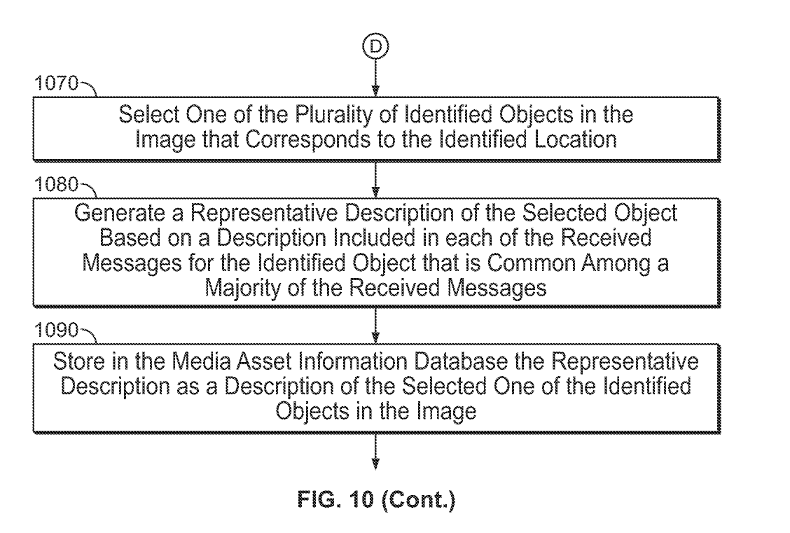

Remote server 415 may store as information associated with the media asset the data that is generated based on the messages received from the crowd of users. Specifically, remote server 415 may store as the information the representative value (e.g., computed average) of the playback position as the playback position of the object, the representative value of the (e.g., computed average) display location as display location of the object displayed at the playback position of the media asset, and/or the computed majority of description information as a description information for the object within the media asset. Control circuitry 304 may deliver or make available the stored information to a user who requests access or retrieval of the media asset associated with the information. Control circuitry 304 of a device used to access the media asset may use the retrieved information to indicate availability of the information (e.g., by displaying indicator 552) and display the information in window 610 when indicator 552 is selected. In some embodiments, control circuitry 304 may determine where the object, identified by the message, is displayed in an image by comparing the representative location of the object with a list of possible object display locations. Based on this determination, control circuitry 304 may determine where to position indicator 552 in the display and which portions of the displayed media asset to make available for displaying information. The process used by control circuitry 304 to identify which of a plurality of objects displayed in an image of the media asset corresponds to the object identified by the messages is discussed in more detail below in connection with FIG. 10.

FIG. 7 shows an illustrative display screen 700 of media object information entry for a displayed object in the media asset in accordance with an embodiment of the invention Screen 700 includes a media asset information region 710, an object description region 730 and a selected object identifier 720. Control circuitry 304 may generate for display in display 700 a send option 740 and a cancel option 750.

Media asset information region 710 may include information identifying media asset 510 from which selection of indicator 542 (FIG. 5) was received. Specifically, control circuitry 304 may retrieve a data structure associated with media asset 510 from storage 308 and generate media asset information region 710 based on the information stored in the associated data structure for media asset 510. For example, media asset information region 710 may include a title of media asset 510 or some other suitable unique identifier. Media asset information region 710 may include a time/position indicator identifying the playback position when selection of indicator 542 was received. For example, control circuitry 304 may determine a playback position (e.g., 20 minutes past the start of the media asset playback or access) when user selection of indicator 542 was received and store that playback position. Control circuitry 304 may display that playback position in region 710. Media asset information region 710 may include an object display location identifying the display location of the object corresponding to indicator 542 that was selected. For example, control circuitry 304 may determine display location (e.g., x and y coordinates and distance between the points of the object) corresponding to the object associated with indicator 542 that was selected and store that display location. In some implementations, the display location may correspond to any geometric shape (circle, square, and triangle) in 2-D or 3-D space substantially near the area corresponding to indicator 542. Control circuitry 304 may display that display location in region 710.

Selected object identifier 720 may provide a visual representation of the object that was selected. For example, control circuitry 304 may copy out of the image displayed in media asset 510 a region of the image corresponding to the geometric shape associated with the display location. The copied portion of the displayed image may be presented in identifier 720 to remind the user about what object the user indicated a desire to provide description information by selecting indicator 542. In some embodiments, identifier 720 may be a short clip of the selected object region.

Object description region 730 may include options for the user to supply or input description information for the object corresponding to indicator 542 and identified by identifier 720. Object description region 730 may include a type option 732, a detail option 734, a website option 736 and a related information option 738. Object type option 732 may allow the user to input information identifying the type of object the user selected. For example, the user may identify the object as a character, actor, item, background, advertisement, product, or any other suitable type. In response to receiving a user selection of object type option 732, control circuitry 304 may display a list of possible types for the user to choose from and may store the user's selection of the type. Detail option 734 may allow the user to input information describing the object the user selected. For example, the user may include a detailed description, such as the name of a person playing the character, name of the mountain (if the object is a mountain), name of a product (if the object is an advertised product), information about the character in the media asset in the context of the plot (e.g., when the selected object is a character), role name of the character when the object selected is a character, name of a region, GPS coordinates, location of the object, population of the region in which the scenery takes place or any other suitable biographical information. In response to receiving a user selection of detail option 734, control circuitry 304 may display a textual entry box for the user to use to supply information and may store the user supplied information.

Website option 736 may allow the user to input information specifying a website or URL associated with the object the user selected. For example, the user may provide a name of a website or entity that sells the product when the object is a product being advertised. In response to receiving a user selection of website option 736, control circuitry 304 may display a textual entry box for the user to use to supply the website URL and may store the user supplied website URL. Related information option 738 may allow the user to input information specifying content (e.g., media assets) related to the object the user selected. For example, the user may provide a title or identifier of another media asset in which an actor, playing a character selected by the user, performs or acts. In response to receiving a user selection of related information option 738, control circuitry 304 may display a textual entry box for the user to use to supply the related media assets and may store the user supplied media assets.

In some embodiments, control circuitry 304 may process the image of the selected object (e.g., identifier 720) to perform facial recognition on the selected object. Control circuitry 304 may cross-reference the facially recognized image with a database of stored faces to determine whether the face in the image is known (e.g., is a popular actor or celebrity). In response to determining the selected object is known (e.g., corresponds to a celebrity based on the automatically performed facial recognition), control circuitry 304 may automatically populate object description region 730 and allow the user to make any desired modifications to the information provided in region 730. For example, control circuitry 304 may search the Internet for any information associated with the celebrity recognized in the image and use the identified information to populate region 730. In some embodiments, control circuitry 304 may continuously or periodically process images of media assets 510 consumed by the user and perform facial recognition to determine whether any objects being displayed are known or have previously stored representations. In response to determining that an object being displayed is known or has previously stored representations, control circuitry 304 may search the Internet for information about the recognized object and automatically populate description information associated with the object to display indicator 552 (indicating information is available) instead of indicator 542 (indicating no information is available).

In response to receiving a user selection of send option 740, control circuitry 304 may automatically generate a message that includes the media asset information in region 710 and object description in region 730 and transmit the message to remote server 415. Remote server 415 may receive the message and generate the entry corresponding to the message in database 800. In response to receiving the user selection of cancel option 750, control circuitry 304 may discard any changes made in screen 700 and navigate the user back to screen 500 and playback media asset 510.

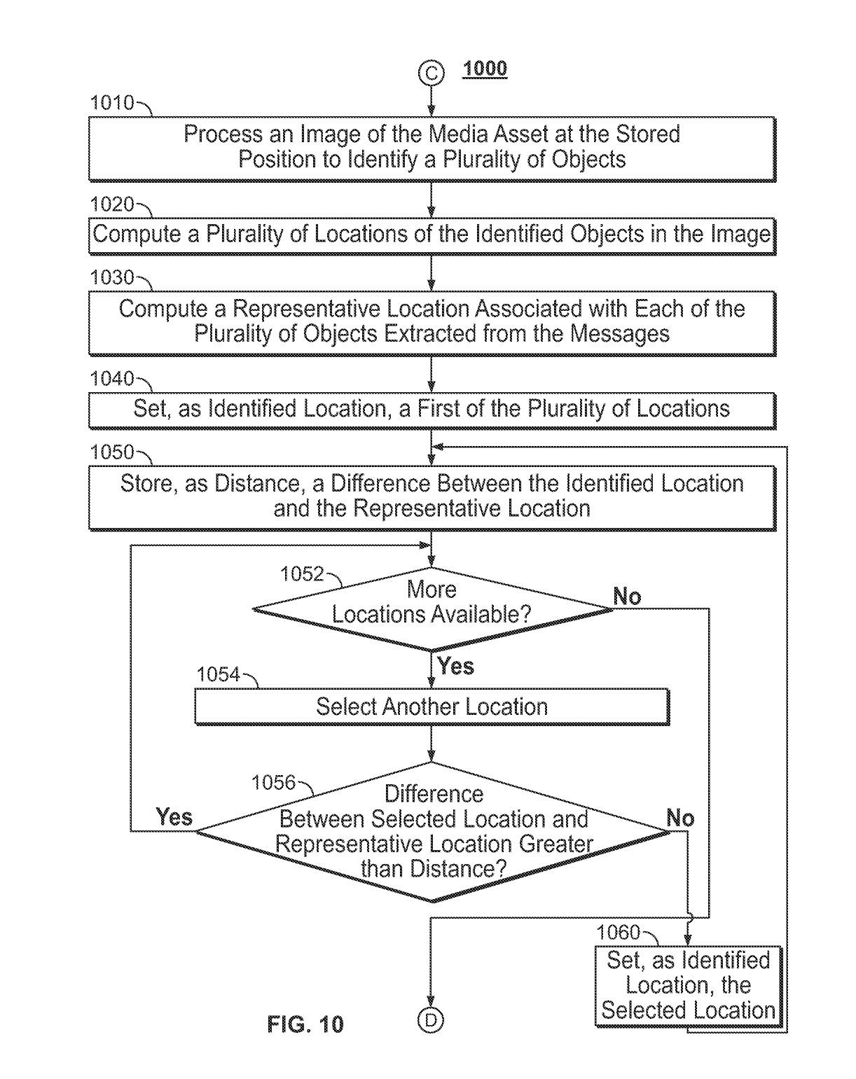

FIG. 9 is a diagram of a process 900 for identifying a media asset object position using messages received from a plurality of users in accordance with embodiments of the invention. Specifically, in some implementations, process 900 of FIG. 9 may be a process that the media guidance application may instruct control circuitry 304 to perform. In some implementations, process 900 of FIG. 9 may be a process or instructions stored in an instruction memory of processing circuitry on a remote server and which remote server 415 is configured to perform.

At step 910, messages from a plurality of users are received. For example, remote server 415 may receive communications from user equipment devices 300 of each of a plurality of users. The communications may be transmitted to remote server 415 as email messages, SMS messages, TCP/IP packets, instant messages, messages posted to a social network, or any other form of packet that carries electronic information. The communications may be automatically generated by each user equipment device 300 based on a request from a user of user equipment device 300 to identify an object being displayed in media asset 510.

At step 920, the messages are processed to extract media asset information and an identified object displayed in the media asset. For example, remote server 415 may process information stored in each message and extract media asset information (e.g., a program title or unique identifier of a program) stored in the messages and object information (e.g., playback position, display location, and/or object description information) stored in the messages.

At step 930, a query that includes the media asset information for a selected one of the messages is generated. Remote server 415 may generate an SQL query that includes the extracted media asset information and transmit the SQL to a media asset database.

At step 940, the generated query is transmitted to a media asset information database to identify a media asset that is associated with the received messages. For example, the query may be transmitted to database 800. Database 800 may be instructed by the query to process field 820 of database 800 to determine whether any of the entries stored in database 800 have data stored in field 820 that matches the media asset information in the generated query. In particular, database 800 may determine whether any previously stored entries in database 800 correspond to a same or similar media asset as the selected message from one of the users.

At step 950, a determination is made as to whether the selected message is associated with a media asset of a previous message. In response to determining that the selected message is associated with a media asset of a previous message, the process proceeds to step 960, otherwise the process proceeds to step 980. For example, database 800 may return to remote server 415 an indication of whether entries matching the media asset information in the selected message exist and if so, a number of entries that correspond to a media asset that matches the media asset information in the selected message. For example, remote server 415 may generate an SQL query that includes instructions for database 800 to retrieve for each entry in database 800 that corresponds to the media asset identified in the selected message playback positions, display positions, and/or description information for the objects identified by the stored entries from fields 830, 840 and/or 850, respectively.

At step 960, a playback position and/or display location specified in a selected message is retrieved. For example, remote server 415 may retrieve from the selected message the specified playback position and/or display location of the object extracted from the message. Remote server 415 may generate an SQL query or instruction to database 800 to add an entry for the selected message and populate fields of the entry with the media asset information extracted from the selected message and the playback positions and/or display locations of the object identified in the selected message.

At step 970, the retrieved playback position and/or display location is accumulated with playback positions and/or display locations of previous messages. For example, remote server 415 may compute a sum of the playback positions retrieved from database 800 that correspond to the media asset information of the selected message and may add to the computed sum the value of the playback position of the object identified by the selected message. Remote server 415 may compute a sum of the display locations retrieved from database 800 that correspond to the media asset information of the selected message and may add to the computed sum the value of the display location of the object identified by the selected message.

At step 980, a determination is made as to whether more messages are available. In response to determining that more messages are available, the process proceeds to step 982, otherwise the process proceeds to step 990.

At step 982, a next one of the received messages is selected. For example, remote server 415 may select another message from the received plurality of messages for which the object identification and media asset information has not yet been compared using database 800.

At step 990, an average of the accumulated position playback positions and/or the accumulated display locations is computed. For example, remote server 415 may transmit an SQL query to database 800 that includes media asset information that is common to the plurality of messages and a request for number of matches. In response, database 800 may count how many entries in database 800 have fields 820 that match the media asset information in the SQL query and return to remote server 415 the number of entries. This number may represent the total number of messages that correspond to a give media asset. Remote server 415 may divide the computed sum of the playback positions and/or display locations by the number of messages to determine the average playback positions and/or display locations of the object displayed in the media asset.

At step 992, a playback position and/or display location of the object displayed within the media asset represented by the average playback positions and/or display locations is stored in the media asset information database.

At step 994, the playback position and/or display location and description information (discussed in connection with FIG. 10) of the object displayed within the media asset is transmitted to a user equipment device. For example, remote server 415 may receive a request from a user equipment device 300 for media asset information associated with a given media asset being accessed by user equipment device 300. In response, remote server 415 may retrieve the stored average playback positions and/or display locations and description information from the media asset information database and transmit the retrieved information to user equipment device 300.

At step 996, a display is generated representing availability of the information for the object when the media asset is accessed at the playback position. For example, control circuitry 304 may generate indicator 552 for display with object 550 (FIG. 5). In response to receiving a user selection of indicator 552, control circuitry 304 may generate for display window 610 that includes information received from remote server 415 generated based on a plurality of messages received from a plurality of users (FIG. 6).

FIG. 10 is a diagram of a process 1000 for identifying an object in an image and generating information for the object using messages received from a plurality of users in accordance with embodiments of the invention. Specifically, in some implementations, process 1000 of FIG. 10 may be a process that the media guidance application may instruct control circuitry 304 to perform. In some implementations, process 1000 of FIG. 10 may be a process or instructions stored in an instruction memory of processing circuitry on a remote server and which remote server 415 is configured to perform.

At step 1010, an image of the media asset presented at the stored position is processed to identify a plurality of objects. For example, remote server 415 may retrieve the media asset corresponding to the received plurality of messages and access the image at the computed average of the playback positions. Remote server 415 may process the image to identify a plurality of objects being displayed in the image.

At step 1020, a plurality of locations of the identified objects in the image are computed. For example, remote server 415 may compute display positions that correspond to the display positions received in the messages (e.g., x and y coordinates of the representative geometric shape surrounding the identified object).

At step 1030, a representative location associated with each of the plurality of objects extracted from the messages is computed. For example, remote server 415 may retrieve the computed average of the display locations.

At step 1040, a first of the plurality of locations is set as the identified location. For example, remote server may retrieve a first display location of the generated display locations in the image.

At step 1050, a difference between the identified location and the representative location is stored as a distance.

At step 1052, a determination is made as to whether more locations are available. In response to determining more locations are available, the process proceeds to step 1054, otherwise the process proceeds to step 1070.

At step 1054, another location is selected. For example, remote server 415 may retrieve a next display location of the generated display locations in the image.

At step 1056, a determination is made as to whether a difference between the selected location and the representative location is greater than the stored distance. In response to determining the difference is greater, the process proceeds to step 1052, otherwise the process proceeds to step 1060.

At step 1060, the selected location is set as the identified location.

At step 1070, one of the plurality of identified objects in the image that corresponds to the identified location is selected. For example, remote server 415 may select the one of the identified objects in the image that is bounded by the geometric shape corresponding to the selected display location.

At step 1080, a representative description of the selected object is generated based on a description included in each of the received messages for the identified object that is common among a majority of the received messages.

At step 1090, the representative description is stored in the media asset information database as a description of the selected one of the identified objects in the image.

It should be understood, that the above steps of the flow diagrams of FIGS. 9 and 10 may be executed or performed in any order or sequence not limited to the order and sequence shown and described in the figures. Also, some of the above steps of the flow diagrams of FIGS. 9 and 10 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for identifying objects displayed in a media asset, the method comprising:
receiving, at a remote server, a plurality of messages from a plurality of users, wherein each message identifies an object displayed in the media asset;
processing the received messages to extract media asset information and the identified object;
cross-referencing the extracted media asset information of each message with a media asset information database to identify the media asset that corresponds to each of the received messages;
processing the identified objects extracted from each of the plurality of messages to generate information describing the identified object; and
storing in the media asset information database, for the media asset that corresponds to each of the received messages, the generated information for the identified object.

2. The method of claim 1, wherein the remote server is associated with a social network, website, blog or news site.

3. The method of claim 1, wherein the generated information includes a name of the identified object, product information, or biographic description of the identified object.

4. The method of claim 1, wherein the identified object is a character in the media asset, product being advertised, or items included in a scene of the media asset.

5. The method of claim 1, wherein the identified objects are selected from an image of the media asset, wherein the identified objects include a playback position within the media asset, and wherein processing the identified objects comprises:
processing the image of the media asset at the playback position to identify a plurality of objects in the image;
computing a plurality of locations of the identified objects in the image;
computing a representative location associated with each of the plurality of objects extracted from the messages;
comparing the plurality of locations of the identified objects in the image with the representative location;
determining which one of the plurality of objects in the image is associated with a location that is closest to the representative location; and
generating the information based on the object in the image determined to be associated with the location that is closest to the representative location.

6. The method of claim 5, wherein computing the representative location comprises computing an average of the positions of each of the extracted identified objects.

7. The method of claim 5 further comprising generating a representative description of the selected object based on a description included in each of the received messages for the identified object that is common among a majority of the received messages.

8. The method of claim 1 further comprising transmitting the information describing the identified object to user equipment, wherein the user equipment displays the information describing the identified object when the user equipment displays the identified object in the media asset.

9. The method of claim 1, wherein a first of the plurality of messages is generated by user equipment associated with a first of the plurality of users by:
displaying an image of the media asset with the user equipment;
receiving a first input from the first user at the user equipment selecting an object displayed in the image;
receiving a second input from the user at the user equipment scribing the selected object; and
adding the description of the selected object to the first message.

10. The method of claim 9, wherein the image includes a plurality of objects, further comprising displaying an indication with each of the plurality of objects that indicates whether descriptive information is available for display for the respective object, wherein the selected object is associated with an indication that indicates that descriptive information is not available for display for the selected object.

11. A system for identifying objects displayed in a media asset, the system comprising:
control circuitry configured to:
receive, at a remote server, a plurality of messages from a plurality of users, wherein each message identifies an object displayed in the media asset;
process the received messages to extract media asset information and the identified object;
cross-reference the extracted media asset information of each message with a media asset information database to identify the media asset that corresponds to each of the received messages;
process the identified objects extracted from each of the plurality of messages to generate information describing the identified object; and
store in the media asset information database, for the media asset that corresponds to each of the received messages, the generated information for the identified object.

12. The system of claim 11, wherein the remote server is associated with a social network, website, Wog or news site.

13. The system of claim 11, wherein the generated information includes a name of the identified object, product information, or biographic description of the identified object.

14. The system of claim 11, wherein the identified object is a character in the media asset, product being advertised, or items included in a scene of the media asset.

15. The system of claim 11, wherein the identified objects are selected from an image of the media asset, wherein the identified objects include a playback position within the media asset, and wherein the control circuitry is further configured to:
process the image of the media asset at the playback position to identify a plurality of objects in the image;
compute a plurality of locations of the identified objects in the image;
compute a representative location associated with each of the plurality of objects extracted from the messages;
compare the plurality of locations of the identified objects in the image with the representative location;
determine which one of the plurality of objects in the image is associated with a location that is closest to the representative location; and
generate the information based on the object in the image determined to be associated with the location that is closest to the representative location.

16. The system of claim 15, wherein the control circuitry is further configured to compute an average of the positions of each of the extracted identified objects.

17. The system of claim 15, wherein the control circuitry is further configured to generate a representative description of the selected object based on a description included in each of the received messages for the identified object that is common among a majority of the received messages.

18. The system of claim 11, wherein the control circuitry is further configured to transmit the information describing the identified object to user equipment, wherein the user equipment displays the information describing the identified object when the user equipment displays the identified object in the media asset.

19. The system of claim 11, wherein a first of the plurality of messages is generated by user equipment associated with a first of the plurality of users by:
displaying an image of the media asset with the user equipment;
receiving a first input from the first user at the user equipment selecting an object displayed in the image;
receiving a second input from the user at the user equipment describing the selected object; and
adding the description of the selected object to the first message.

20. The system of claim 19, wherein the image includes a plurality of objects, and wherein the control circuitry is further configured to display an indication with each of the plurality of objects that indicates whether descriptive information is available for display for the respective object, wherein the selected object is associated with an indication that indicates that descriptive information is not available for display for the selected object.

21-30. (canceled)
